(19) United States
(12) Patent Application Publication
(10) Pub. No.: US 2014/0167526 A1
(43) Pub. Date: Jun. 19, 2014

(54) ELECTRONIC CONTROL OF AC SUPPLY

(71) Applicant: ADVANCED ENVIRONMENTAL TECHNOLOGIES LIMITED, Auckland (NZ)

(72) Inventor: Mohamed SIRAJUDDIN, Chennai (IN)

(73) Assignee: ADVANCED ENVIRONMENTAL TECHNOLOGIES LIMITED, Auckland (NZ)

(21) Appl. No.: 14/104,275

(22) Filed: Dec. 12, 2013

Related U.S. Application Data
(60) Provisional application No. 61/736,731, filed on Dec. 13, 2012.

(51) Int. Cl. H02M 1/42

(52) U.S. Cl. CPC H02M 1/42
USPC 307/109

(57) ABSTRACT

A power controller having a switchable capacitive load connectable to an AC supply, the switchable capacitive load including at least one RC network having one or more capacitors. The capacitors have at least one resistive load switchable in place across the capacitors. The resistive load is switchable by a resistive load switch to connect the resistive load across the one or more capacitors when the capacitive load is not switchably connected to the AC supply and to disconnect when the capacitive load is connected to the AC supply. The resistive load switch is powered from the remnant voltage across the capacitors.

### TECHNICAL FIELD

The invention generally relates to the control of the relative current and voltage relationship of the phases of an electrical AC supply and ancillaries to support this.

More particularly the invention relates to control of an AC supply particularly for use in controlling the relationship between the phase of the current and of the voltage of an AC supply but includes ancillary uses for the control circuitry.

### BACKGROUND OF THE INVENTION

Transmission of AC power to a remote load is normally assumed to supply an AC waveform in which the current and voltage are in phase for greatest power transfer. This is not the usual case, however, and the loads presented by residential and commercial loads generally provide a reactive and non-linear load, typically inductive, to the power line, resulting in a difference in the phase of voltage and current, normally expressed as a difference angle θ (hereinafter referred to as “phase angle”). There may also be high harmonic content and additional voltage spikes, both of which affect the connected equipment.

Since this non-zero phase angle supply requires a higher current for the same wattage a non-zero phase angle, or non-unity power factor (cos θ), forces the use of supply lines with greater current capacity, which cost more to provide. To help in correcting a non-zero phase angle power companies normally provide power factor correction at distribution points on the network by means such as synchronous condensers. Despite this the load at each consumer still normally presents an inductive load which is not fully compensated resulting in a non-unity power factor and reduced efficiency in the power distribution system and in the use of the power at the consumer premises. Many electricity suppliers base their charges on the component of power used at zero phase angle or penalise power factors smaller than a certain value, such as 0.7, in an effort to encourage greater efficiency by consumers.

Various methods of providing correction at consumer premises have been proposed, such as capacitor banks floated across the consumer line. Such capacitors are normally selected based on the expected load or the prevailing power factor and are not variable. Additionally these methods are expensive to implement and do not necessarily provide a consistent unity power factor.

Therefore a need exists for a solution to the problem of providing a method of reducing excessive current consumption because of a reactive component in the provided AC supply and producing almost a unity power factor at the consumer point in a similar manner to the applicants U.S. patent application Ser. No. 15/525,235.

U.S. Pat. No. 4,567,424 discloses the use of discharge resistors connected in parallel with the capacitors of a power factor reducing apparatus and effectively disconnected when the capacitor is carrying current and connected when the capacitor is not carrying current. The control of the resistor switching requires expensive inductive components to perform the switching action.

Other methods of discharging capacitor residual voltage require AC circuits which tends to provide expensive implementation.

The present invention provides a solution to this and other problems which offers advantages over the prior art or which will at least provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein; this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

### BRIEF SUMMARY OF THE INVENTION

In one exemplification the invention consists in a power controller having a switchable capacitive load connectable to an AC supply, the switchable capacitive load including at least one RC network consisting of a one or more capacitors, the capacitors having at least one resistive load switchable in place across the capacitors, the resistive load being switchable by a resistive load switch to connect the resistive load across the one or more capacitors when the capacitive load is not switchably connected to the AC supply and to disconnect when the capacitive load is connected to the AC supply, the resistive load switch being powered from the remanent voltage across the capacitors.

Preferably multiple different capacitive loads are capable of being simultaneously connected in parallel or in series with the AC supply in dependence on the loading required, each different capacitive load having an associated resistive load switchable across the capacitive load when it is not connected to the AC supply.

Preferably the value in ohms of the resistive load switchable across a capacitive load, divided by the capacitance value in farads of the capacitors forming the capacitive load is a constant for each capacitive load connected to the AC supply.

Preferably the resistive load is switchable across the capacitive load by the resistive load switch, the resistive load switch being powered from a rectifier bridge across the capacitive load.

Preferably the switching circuit switching the resistive load switchably connects the resistive load across the capacitive load in the absence of a control signal.

In an alternative embodiment the invention consists in a method of switching across or in series with an AC supply a capacitive load by providing at least one capacitive load for connection to the AC supply, providing a switch to connect the capacitive load to or disconnect the capacitive load from the AC supply, providing a resistive load and a resistive load switch for each capacitive load for connection of the resistive load in parallel with the capacitive load, detecting when the switch is not connecting the capacitive load to the AC supply and connecting the associated resistive load in parallel across each capacitive load via the resistive load switch when the capacitive load is not connected to the AC supply, the resistive load switch being powered by the remanent voltage across the capacitor.

Preferably the method includes powering a switch to provide the connecting of the associated resistive loads the switch power being direct current provided from the rectifying bridge connection across the capacitive load.

Preferably the switching across or in series with an AC supply provides for connecting multiple differing capacitive loads across or in series with the AC supply.

Preferably the switching across or in series with an AC supply provides for connecting multiple differing capacitive loads across or in series with the AC supply and each of said multiple differing capacitive loads has an associated parallel resistance and the product of the resistance in ohms and the capacitance in farads is a constant for all of said multiple differing capacitive loads.

These and other features of as well as advantages which characterise the present invention will be apparent upon reading of the following detailed description and review of the associated drawings.

### BRIEF DESCRIPTION OF THE DRAWINGS

FIG. 1 is a general block diagram of an AC supply using multiple switched capacitive loads.

FIG. 2 is a circuit diagram of a voltage and current phase detector for the invention.

FIG. 3 is a circuit of a switching module suitable for switching an AC supply to multiple differing capacitive loads.

FIG. 4 is a circuit of two capacitive loads each with an associated parallel connected resistive load which is connected only when the AC supply is not connected.

FIG. 5 is the circuit for discharge of the capacitive loads via resistors

### DESCRIPTION OF THE INVENTION

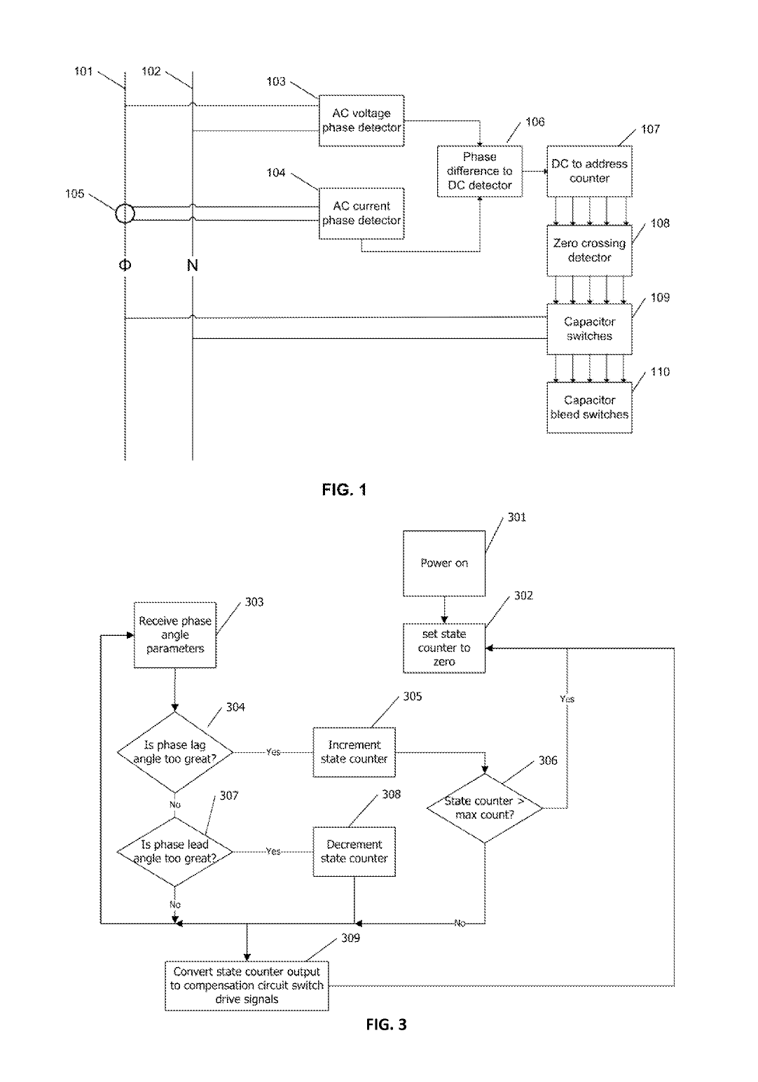

Referring now to FIG. 1 a block diagram of an electronic power factor controller is shown. The controller places across an AC supply 101, 102 various switchable capacitive loads to control the difference in phase between the current on the supply line and the voltage of the supply line. This is accomplished by using an AC voltage phase detector 103, an AC current phase detector 104, and a relative phase angle detector 106 detecting whether the AC current is leading or lagging the voltage and appropriately incrementing or decrementing a comparative phase angle counter 107. The applicants U.S. application Ser. No. 12/525,235 describes such a circuit.

The count at the counter 107 switches on or off various ones of capacitive loads at 109 through zero-crossing detectors 108. Capacitor bleed resistors are switched at 109 by capacitor bleed switches 110 to remove any residual charge in the disconnected capacitors.

While the diagram shows the current tapped from the AC voltage supply it may equally well be taken from a one or two turn winding around one of the supply conductors.

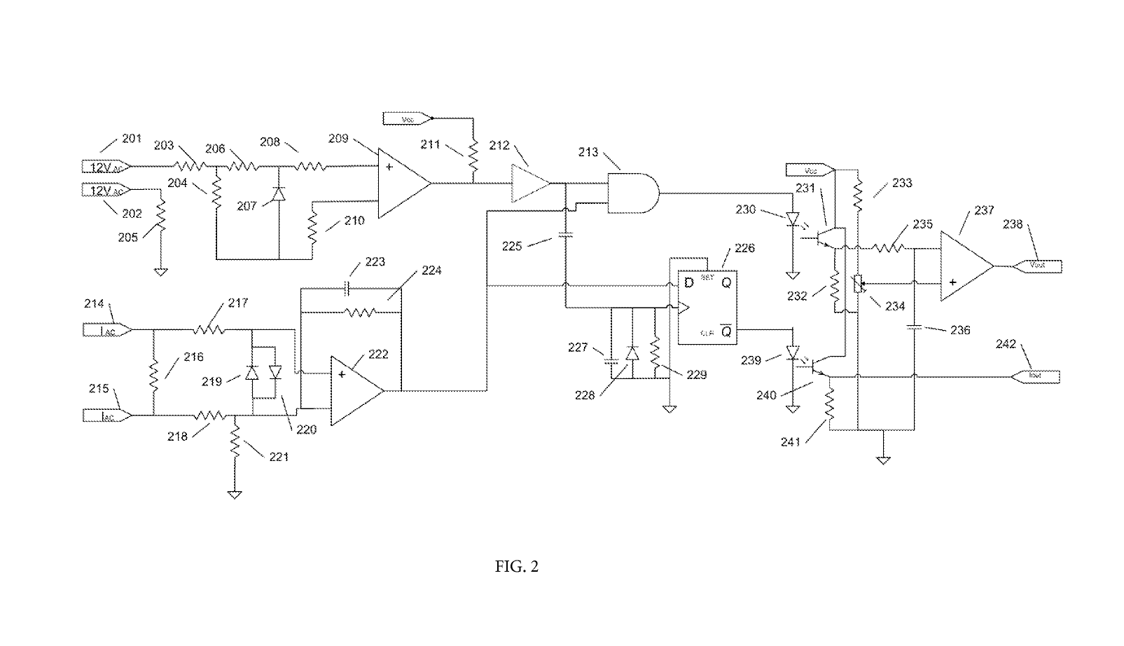

FIG. 2 details the circuitry of one option for deriving an indication of whether the phase of the voltage is leading or lagging that of the current. Terminals 201 and 202 receive the AC voltage supply as in FIG. 1 and supply it through the current limiting resistor 203 to a voltage polarising network of resistors 204, 206, 208 and 210 which produces a half wave rectified AC voltage to op amp 209. The output of op-amp 209, which is effectively a square wave with a transition at each zero crossing, is stabilised high by resistor 211 and further shaped by buffer 212.

A current signal from a loop around an AC supply wire or a similar source is applied to terminals 214, 215 to produce a voltage across low value resistor 216. This voltage is applied through resistors 217, 218 to op amp 222 with diodes 219, 220 acting to limit any voltage peaks and resistor 221 stabilising the operating point. Op-amp 222 has a high stop filter of capacitor 223 and resistor 224 in the feedback loop to reduce spikes.

The output of op-amp 222, which is substantially a square wave with transitions at the zero crossing points of the AC current waveform, is directed to AND gate 213 together with the AC voltage square wave. The output from AND gate 213 is therefore a differing mark/space ratio square wave with the ratio differing for the phase difference between current and voltage. The square wave representing the magnitude of the phase difference is output from AND gate 213 to an opto-coupler of LED 230 and phototransistor 231 providing the input to op-amp 237, with an integrator of resistor 235 and capacitor 236 and with the zero point set by potentiometer 234. The resulting varying DC is amplified in the op-amp 237 and provides a DC output at 238 which is either a logic high or a logic low dependent on whether the phase difference detected is large or small.

The output of the op-amp 222 is also directed to a data driven flip-flop 226 as the data input. The flip-flop is clocked by the voltage square wave from buffer 212 with the result that if the voltage phase is leading the current phase the flip-flop will be driven one way, while if the current leads the voltage the flip-flop will be driven the other way.

The sign of the phase difference is output from flip-flop 226 to a photo-coupler of LED 239 and photo-transistor 240 with load resistor 241 setting the output voltage at 241.

The outputs serve as inputs to a microprocessor or complex programmable logic device (CPLD) running an algorithm as shown in FIG. 3. This algorithm counts a state counter up or down at a constant rate against what equates to the difference between the voltage and current zero crossing transitions of the AC supply line. FIG. 3 shows the initialization of the CPLD at 301 with the counter state and any incoming register states being set to zero at 302 before the state counter is started. Following this the incoming phase angle signals are used as interrupts at 303 for stopping the state counter. If the phase angle lag is too great as at 304 this will result in the state counter counting for longer and therefore being incremented at 305, whereas if the phase angle lead is too great as at 307 the state counter is counted for less time and is decremented at 308.

The state counter count is converted at 309 to switching signals to switch various capacitor banks into circuit, maintain them in circuit, or remove them from circuit dependent on the amount of phase lead or lag. If for some reason the state counter is never stopped it will reach a maximum count detected at 306 and will be reset at 302.

The state counter typically provides parallel binary outputs such that each digital bit drives a specific capacitive load correction value. Each incremental binary value will then provide a constant incremental capacitive value to be added to the total load, and similarly a reduction in the binary count will remove a constant decremental value from the load.

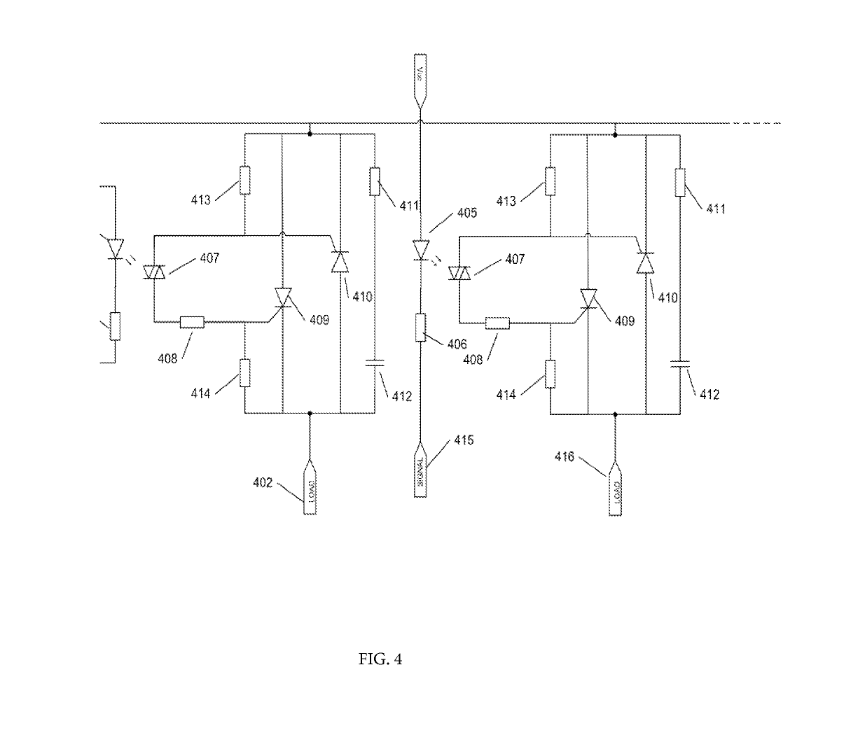

FIG. 4 shows a circuit diagram for multiple identical capacitor switch circuits in which each switch circuit is connected to the AC supply phase line. A switch circuit typically consists of an opto-coupler, for instance LED 405 and photo-triac 407 (as in an MOC3083 integrated circuit) supplied with a DC voltage at 403 and connecting to a binary counter digit output at 404. When the binary output is low the triac 407 is switched on and connects the gates of two thyristors 409, 410. Each gate is driven by the current through one of resistors 413, 414 to turn one of the thyristors on (in accordance with whether the AC line is going positive or negative) to supply current to the capacitive load at 402.

The use of an integrated photo-triac which includes a zero crossing detector ensures that the thyristors are only turned on at or near zero voltage AC voltage which reduces current surges into the capacitive loads. This in turn allows the use of lower surge current capacitors in the capacitive load and hence reduces cost. A snubbing circuit of resistor 411 and capacitor 412 reduces switching spikes.

The second identical switching circuit of FIG. 4 is driven from a different binary counter output 415 and drives a different capacitive load at 416. Typically there may be six differing capacitive loads to provide 2⁶ (2ⁿ) different capacitive combinations each driven by such a switching circuit from a different binary counter output.

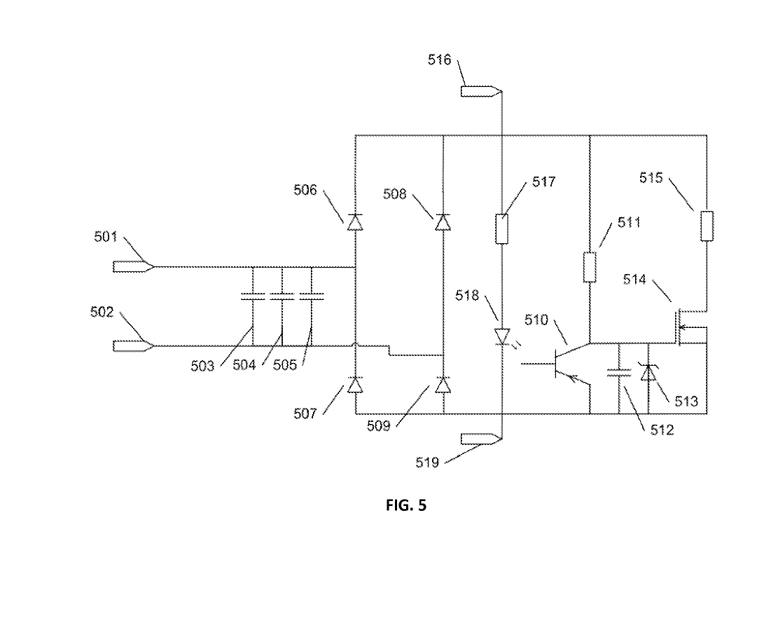

FIG. 5 shows one of the capacitive loads, connecting AC voltage from a capacitor switch circuit of FIG. 4 at 501 to either the opposite AC line or to the AC load at 502, depending on whether the corrective capacitive load is in parallel or series with the AC supply. The capacitive load is made up of one or more capacitors 503, 504, 505 depending on the capacitive value required. The voltage across the corrective capacitive load is applied to a rectifier bridge of diodes 506, 507, 508, 509. The voltage obtained is applied to a phototransistor 510 through resistor 511 and an FET 514 through resistor 515. Resistor 515 exists to bleed away any residual charge across the capacitive load when the capacitor is disconnected from the AC voltage. Typically there is a value of resistance associated with each value of capacitive load such that the product of the values of R and C is a constant, to provide matched discharge curves regardless of which combination of capacitive loads is connected to the AC supply. The RC product is typically for a calculated 3 seconds but may be above or below that value. The voltage across transistor 510 is smoothed by capacitor 512 and limited by zener diode 513.

The voltage supply to FET 514, being derived from the any remanent voltage across capacitors 503, 504, 505 via rectifier bridge 506, 507, 508, 509, will discharge when FET 514 is switched on to the minimum conductive voltage of the FET, normally well below 1 volt, thus discharging the capacitive load.

Transistor 510 is switched on by a signal applied through terminals 516, 519 and resistor 517 to IRED 518. In normal circumstances the transistor is held conductive, but the IRED is turned OFF while the capacitors are connected to the AC load and ON when the capacitive load is disconnected.

This ensures that when a capacitive load is disconnected, which may occur when there is still either a voltage across the capacitors or a current through them, the triggering off of transistor 511 turns on FET 514 and discharges the capacitor through bleed resistor 515. Resistor 515 is not, therefore, connected across the capacitive load while power is applied to the capacitors ensuring that there are no unnecessary losses, but is connected when the capacitors require to be discharged. Because the resistor value varies inversely with the capacitive value it will be clear that the higher the capacitive load the lower the associated resistance and thus if the resistor remained connected permanently, the higher the permanent resistive losses. Disconnecting the bleed resistors while AC is connected removes these losses and additionally allows the use of lower wattage resistors since they are not permanently connected.

The use of a control switch and discharge resistor driven from a bridge allows the discharge of the capacitor with a simple DC circuit regardless of whether the capacitor was disconnected from the AC supply with a positive or a negative voltage across it.

### Variations

While the invention is described in relation to specific circuits these circuit functions can be carried out by other equivalent circuits. For instance while the AC supply switching is carried out by thryistors these could be replaced by digitally driven insulated gate power FETs, IGBTs, etc.

It is to be understood that even though numerous characteristics and advantages of the various embodiments of the present invention have been set forth in the foregoing description, together with details of the structure and functioning of various embodiments of the invention, this disclosure is illustrative only, and changes may be made in detail so long as the functioning of the invention is not adversely affected. For example the particular elements of the electronic controller may vary dependent on the particular application for which it is used without variation in the spirit and scope of the present invention.

In addition, although the preferred embodiments described herein are directed to electronic controllers for use in a current/voltage phase angle control system, it will be appreciated by those skilled in the art that variations and modifications are possible within the scope of the appended claims.

What is claimed is:

1. A power controller having a switchable capacitive load connectable to an AC supply, the switchable capacitive load including at least one RC network consisting of a one or more capacitors, the capacitors having at least one resistive load switchable in place across the capacitors, the resistive load being switchable by a resistive load switch to connect the resistive load across the one or more capacitors when the capacitive load is not switchably connected to the AC supply and to disconnect when the capacitive load is connected to the AC supply, the resistive load switch being powered from the remanent voltage across the capacitors.

2. A power controller as claimed in claim 1 wherein multiple different capacitive loads are capable of being simultaneously connected in parallel or in series with the AC supply in dependence on the loading required, each different capacitive load having an associated resistive load switchable across the capacitive load when it is not connected to the AC supply.

3. A power controller as claimed in claim 1 wherein the value in ohms of the resistive load switchable across a capacitive load, divided by the capacitance value in farads of the capacitors forming the capacitive load is a constant for each capacitive load connected to the AC supply.

4. A power controller as claimed in claim 1 wherein the resistive load is switchable across the capacitive load by the resistive load switch, the resistive load switch being powered from a rectifier bridge across the capacitive load.

5. A power controller as claimed in claim 1 wherein the switching circuit switching the resistive load switchably connects the resistive load across the capacitive load in the absence of a control signal.

6. A method of switching across or in series with an AC supply a capacitive load by providing at least one capacitive load for connection to the AC supply, providing a switch to connect the capacitive load to or disconnect the capacitive load from the AC supply, providing a resistive load and a resistive load switch for each capacitive load for connection of the resistive load in parallel with the capacitive load, detecting when the switch is not connecting the capacitive load to the AC supply and connecting the associated resistive load in parallel across each capacitive load via the resistive load switch when the capacitive load is not connected to the AC supply, the resistive load switch being powered by the remanent voltage across the capacitor.

7. A method as claimed in claim 6 including powering a switch to provide the connecting of the associated resistive loads the switch power being direct current provided from the rectifying bridge connection across the capacitive load.

8. A method as claimed in claim 6 wherein the switching across or in series with an AC supply provides for connecting multiple differing capacitive loads across or in series with the AC supply.

9. A method as claimed in claim 6 wherein the switching across or in series with an AC supply provides for connecting multiple differing capacitive loads across or in series with the AC supply and each of said multiple differing capacitive loads has an associated parallel resistance and the product of the resistance in ohms and the capacitance in farads is a constant for all of said multiple differing capacitive loads.
